(19) United States
(12) Patent Application Publication
(10) Pub. No.: US 2026/0062218 A1
(43) Pub. Date: Mar. 5, 2026

(54) SYSTEMS AND METHODS FOR EQUIPMENT AGNOSTIC CONTROL WITH A WAREHOUSE EXECUTION SYSTEM

(71) Applicant: Savoye North America, Inc., Aurora, IL (US)

(72) Inventors: Daniel Avram, Reading, PA (US); William Bartok, Rochester, NY (US); Zachary Ronayne, West Chester, PA (US)

(21) Appl. No.: 19/310,467

(22) Filed: Aug. 26, 2025

Related U.S. Application Data
(60) Provisional application No. 63/687,951, filed on Aug. 28, 2024.

(51) Int. Cl. B65G 1/137; G06Q 10/20

(52) U.S. Cl. CPC B65G 1/1373; G06Q 10/20

(57) ABSTRACT

A method of operating a materials handling system includes receiving a request associated with the materials handling system and identifying an automation device included in the materials handling system that can be used to service the request, the automation device associated with a vendor. The method further including generating, by a device manager implemented in a warehouse execution system (WES), a universal command for controlling the automation device to service the request, generating, by a communication microservice implemented in the WES based in part on the universal command, a vendor-specific command that is in a format associated with the vendor, and controlling the automation device in accordance with the vendor-specific command.

### CROSS-REFERENCE TO RELATED APPLICATION

This application claims the benefit of co-pending U.S. Provisional Ser. No. 63/687,951 , filed Aug. 28, 2024, the entire contents of which are incorporated by reference.

### TECHNICAL FIELD

This disclosure generally relates to warehouse execution systems. More specifically, this disclosure relates to systems and methods for equipment agnostic control of automation devices with a warehouse execution system.

### BACKGROUND

Operations within a distribution center (e.g., a facility that stores and distributes finished goods to retail locations, consumers, and other end customers) and/or a warehouse (e.g., a storage facility for raw materials and parts used in manufacturing operations) can be managed using a warehouse execution system (WES). A WES is a software-based control system that orchestrates, through automated control of various types of materials handling and/or automation equipment, the flow of products (e.g., from receiving through shipping) within a warehouse or distribution center. Automation and/or materials handling equipment can include, without limitation, conveyor systems, lifts, cranes, shuttles, automated storage and retrieval systems, robotic arms, lifts, pick to light systems, displays, and/or any other devices that may be implemented in a materials handling system. Hereinafter, materials handling and/or automation equipment may simply be referred to as automation equipment and/or automation devices.

In operation, the WES software organizes sequences and directs resources within a distribution center or warehouse (e.g., workers, automation equipment, etc.) to move goods. For example, WES software controls automation equipment and/or directs workers to receive and sort inbound products for storage, put away received goods into storage, replenish picking locations with goods from storage; pick customer orders, assemble orders, check orders, pack orders, and/or load and ship orders.

Oftentimes, the distribution center and/or warehouse in which the WES is implemented includes pieces of automation equipment that are sourced from different vendors (e.g., different manufacturers). As an example, a goods-to-person (GTP) station included in a distribution center may include a pick to light system sourced from a first vendor, an automated storage and retrieval system (ASRS) sourced from a second vendor, a projector sourced from a third vendor, a pick to light system sourced from the fourth vendor, and user-interface sourced from a fifth vendor. Hereinafter, pick to light systems can also be referred to as “pick lights.”

In a conventional approach to designing WES software for use with pieces of automation equipment sourced from different vendors, the WES software is typically custom engineered as a monolithic application that interfaces and communicates directly with each of the individual pieces of automation equipment. For example, with reference to the GTP station described above, a conventional WES may comprise a monolithic application that is custom engineered to interface and communicate directly with a conveyor sourced from the first vendor, an ASRS sourced from the second vendor, a projector sourced from the third vendor, a pick light sourced from the fourth vendor, and a user-interface sourced from a fifth vendor. In that regard, when a pick order is received by the conventional WES system, to service the pick order, the conventional WES software generates one or more first vendor-specific commands for directly controlling the conveyor, generates one or more second vendor-specific commands for directly controlling the ASRS, generates one or more third vendor-specific commands for directly controlling the projector, generates one or more fourth vendor-specific commands for directly controlling the pick light, and generates one or more fifth vendor-specific commands for directly controlling the user-interface.

At least one drawback to this approach, however, is that repairing and/or replacing malfunctioning pieces of automation equipment that are controlled by a conventional WES can be exceedingly expensive. Because conventional WES software is typically custom engineered to interface and communicate only with pieces of automation equipment sourced from particular vendors, technicians are limited with respect to the vendors from which replacement pieces of automation equipment can be sourced. Thus, even if replacement pieces of automation equipment sourced from additional vendors cost significantly less money than replacement pieces of automation equipment sourced from the particular vendors that are compatible with conventional WES software, technicians are forced to purchase the more expensive replacement pieces of automation equipment. For example, if a conveyor sourced from a first vendor and controlled by a conventional WES fails, to avoid significant downtime in the distribution center, a replacement conveyor must be sourced from the first vendor even if other vendors offer similar conveyor pieces at lower prices.

At least another drawback to this approach is that when a piece of automation equipment sourced from a particular vendor fails, the distribution center or warehouse within which the failed piece of automation equipment is installed will experience significant amounts of downtime if a replacement piece of automation equipment cannot be readily acquired from the particular vendor. As described herein, a conventional WES software typically includes a monolithic application that is custom engineered to interface and communicate only with pieces of automation equipment sourced from particular vendors. In that regard, once the conventional WES software is commissioned in a distribution center or warehouse, the monolithic application comprising the WES software cannot be easily or quickly modified to accommodate automation equipment sourced from new vendors. Therefore, if a limited availability of replacement pieces of automation equipment forces technicians to source a replacement piece of automation equipment from a new vendor, a significant amount of time and engineering resources will be spent rewriting the monolithic application to interface and communicate with the replacement piece of automation equipment from the new vendor.

As the foregoing illustrates, what is needed in the art are more effective techniques for controlling automation equipment in a distribution center and/or warehouse.

### SUMMARY

The present teachings are directed to a warehouse execution system (WES) that implements techniques for vendor-agnostic control of automation equipment included in a distribution center or warehouse. As used herein, the meaning of the term “vendor” can encompass the manufacturer of an automation device, the assembler of an automation device, an integrator of an automation device, and/or the distributor of an automation device.

With the disclosed techniques, the proposed WES implements software microservices that disentangle fundamental logic and core functionality of the WES from the vendor-specific requirements of the automation equipment being controlled by the WES. These software microservices may be categorized as “managers” according to the types of automation devices and/or equipment they are adapted to control. For example, the WES software can implement a variety of managers, such as but no limited to, a crane manager for controlling crane equipment, a conveyor routing manager for controlling conveyor equipment, a programmable logic controller (PLC) manager for controlling PLC equipment, a goods-to-person (GTP) manager for controlling GTP equipment, a shuttle manager for controller shuttle equipment, and various other managers.

As will be described in more detail herein, the managers serve as repositories for the algorithms that govern operation of the automation equipment, thereby endowing the WES with the capacity to make decisions independently of the intricacies of equipment-level languages. In operation, the respective managers generate events that communication microservices interpret and subsequently translate directly for seamless communication with the equipment. In essence, the logic is decoupled from the interface specific communication to the equipment. This architectural approach implies that the engine and core functionality are engineered once, constituting a unified system, while the communication aspect operates as an autonomously decoupled program. The communication microservices are designed to actively listen for events and execute translations tailored to the specific requirements of the equipment or host, thereby fostering a modular and interoperable computing environment. Hereinafter, a communication microservice can be referred to as a “CM.”

With the disclosed techniques, an automation device manufactured by a particular vendor can be controlled by the WES using a device manager and a CM specific to that vendor. For example, if the automation device is a crane sourced from a first vendor, the WES may receive a request to store a pallet in long-term storage racks using the crane. In response to receiving this request, the WES uses a crane manager to generate a device-agnostic, or universal, command for controlling a crane to move the pallet to storage. Upon generation of the command for controlling the crane to move the pallet to storage, a CM implemented by the WES receives and translates the universal command into a command formatted in the equipment-level language of cranes sourced from the first vendor. Then, the crane is controlled to store the pallet with the command formatted in the equipment-level language.

When compared to conventional WES software used to control automation devices and equipment, at least one technical advantage of the WES described herein is that technicians have the flexibility to source replacement equipment from whichever vendor offers the best pricing and/or from whichever vendor can supply a replacement piece of equipment the quickest. For example, whereas conventional WES software includes a monolithic application custom engineered to interface and communicate directly with automation equipment sourced only from particular vendors, the software implemented by the proposed WES can be quickly and easily modified to interface and communicate with equipment from any vendor.

With the disclosed techniques, modifying the proposed WES to interface and communicate with automation equipment and/or devices from new vendors merely involves adding a new communication microservice that corresponds to the new vendor of automation equipment to the WES software package. In contrast, modifying a monolithic application included in conventional WES software to interface and communicate with automation equipment from new vendors requires rewriting significant portions of the monolithic application, and consequently, requires significant amounts of time and engineering resources. In that regard, when compared to conventional WES software, the WES described herein provides the technical advantages of significantly reducing both (i) the cost of repairing and/or replacing failed automation equipment can be significantly reduced and (ii) the amount of time required to repair and/or replace failed automation equipment. In addition, the WES described herein can be more easily modified to interface and communicate with new types of automation equipment, thereby allowing the WES to be scaled after deployment in a distribution center or warehouse. Moreover, troubleshooting issues in the WES described herein requires fewer engineering resources and time as a result of containing fewer specialized, monolithic components.

In one independent aspect, a method of operating a materials handling system includes receiving a request associated with the materials handling system and identifying an automation device included in the materials handling system that can be used to service the request, the automation device associated with a vendor. The method further includes generating, by a device manager implemented in a warehouse execution system (WES), a universal command for controlling the automation device to service the request, generating, by a communication microservice implemented in the WES based in part on the universal command, a vendor-specific command that is in a format associated with the vendor, and controlling the automation device in accordance with the vendor-specific command.

In another independent aspect, a materials handling system comprising a plurality of automation devices a computing system that is in electronic communication with the plurality of automation devices. The computing system is adapted to execute a warehouse execution system (WES) engine to receive a request associated with the materials handling system, identify a first automation device included in the plurality of automation devices that can be used to service the request, the first automation device associated with a first vendor, generate, by a device manager, a universal command for controlling the first automation device to service the request, generate, by a communication microservice based in part on the universal command, a vendor-specific command that is in a format associated with the first vendor, and control the first automation device in accordance with the vendor-specific command.

Other aspects will become apparent by consideration of the detailed description and accompanying drawings.

### BRIEF DESCRIPTION OF THE DRAWINGS

In the accompanying drawings, which form a part of the specification and are to be read in conjunction therewith in which like reference numerals are used to indicate like or similar parts in the various views:

FIG. 1 illustrates an example process for controlling automation equipment in a materials handling system, according to the present teachings.

FIG. 2 illustrates an example materials handling system, according to the present teachings.

FIG. 3 is a block diagram of an example warehouse execution system (WES) server included in the materials handling system of FIG. 2, according to the present teachings.

FIG. 4 is a block diagram of another example warehouse execution system (WES) server included in the materials handling system of FIG. 2, according to the present teachings.

FIG. 5 is an example flow diagram of a process for operating a materials handling system in conjunction with a WES, according to the present teachings.

FIG. 6 is a flow diagram of method steps for controlling a materials handling system with a WES, according to the present teachings.

FIG. 7 is a flow diagram of method steps for replacing an automation device in a materials handling system, according to the present teachings.

FIG. 8 illustrates an example goods-to-person (GTP) system, according to the present teachings.

FIG. 9 illustrates an example workflow for controlling a projector using a GTP manager, according to the present teachings.

FIG. 10 illustrates an example workflow for controlling a conveyor using a conveyor routing manager and a programmable logic controller (PLC) manager, according to the present teachings.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

A “computing system” may provide functionality for the present teachings. The computing system may include software executing on computer readable media that may be logically (but not necessarily physically) identified for particular functionality (e.g., functional modules). The computing system may include any number of computers/processors, which may communicate with each other over a network. The computing system may be in electronic communication with a datastore (e.g., database) that stores control and data information. Forms of computer readable media include, but are not limited to, disks, hard drives, random access memory, programmable read only memory, or any other medium from which a computer can read.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Moreover, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more electronic processors, one or more computer-readable medium modules, one or more input/output interfaces, and various connections (e.g., a system bus) connecting the components.

To aid the Patent Office and any readers of a patent issued on this application in interpreting the claims appended hereto, it is noted that none of the appended claims or claim elements are intended to invoke 35 U.S. C. 112(f) unless the words “means for” or “step for” are explicitly used in the particular claim.

Recitations of numerical ranges by endpoints include all numbers within that range (e.g., 1 to 5 includes 1, 1.5, 2, 2.75, 3, 3.80, 4, 5, etc.). Where a range of values is “greater than”, “less than”, etc., of a particular value, that value is included within the range.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

Any direction referred to herein, such as “top,” “bottom,” “left,” “right,” “upper,” “lower,” “above,” “below,” and other directions and orientations are described herein for clarity in reference to the figures and are not to be limiting of an actual device or system or use of the device or system. Many of the devices, articles, or systems described herein may be used in a number of directions and orientations.

Any citation to a reference in this disclosure or during the prosecution thereof is made out of an abundance of caution. No citation (whether in an Information Disclosure Statement or otherwise) should be construed as an admission that the cited reference qualifies as prior art or comes from an area that is analogous or directly applicable to the present teachings.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

The warehouse execution system (WES) described herein implements techniques for device agnostic control of automation equipment included in a distribution center or warehouse. With the disclosed techniques, the proposed WES implements software microservices that disentangle fundamental logic and core functionality of the WES from the vendor-specific requirements of the automation equipment being controlled by the WES. As used herein, the meaning of the term “vendor” can encompass the manufacturer of an automation device, the assembler of an automation device, an integrator of an automation device, and/or the distributor of an automation device.

These software microservices may be categorized as “managers” according to the types of automation devices and/or equipment they are adapted to control. For example, the WES software may implement a variety of managers, such as but no limited to, a crane manager for controlling crane equipment, a conveyor routing manager for controlling conveyor equipment, a programmable logic controller (PLC) manager for controlling PLC equipment, a goods-to-person (GTP) manager for controlling GTP equipment, a shuttle manager for controller shuttle equipment, and various other managers.

The managers serve as repositories for the algorithms that govern operation of the automation equipment, thereby endowing the WES with the capacity to make decisions independently of the intricacies of equipment-level languages. In operation, the respective managers generate events that communication microservices interpret and subsequently translate directly for seamless communication with the equipment. In essence the logic is decoupled from the interface specific communication to the equipment. This architectural approach implies that the engine and core functionality are engineered once, constituting a unified system, while the communication aspect operates as an autonomously decoupled program. The communication microservices are designed to actively listen for events and execute translations tailored to the specific requirements of the equipment or host, thereby fostering a modular and interoperable computing environment. Hereinafter, communication microservices can be referred to as “CMs.”

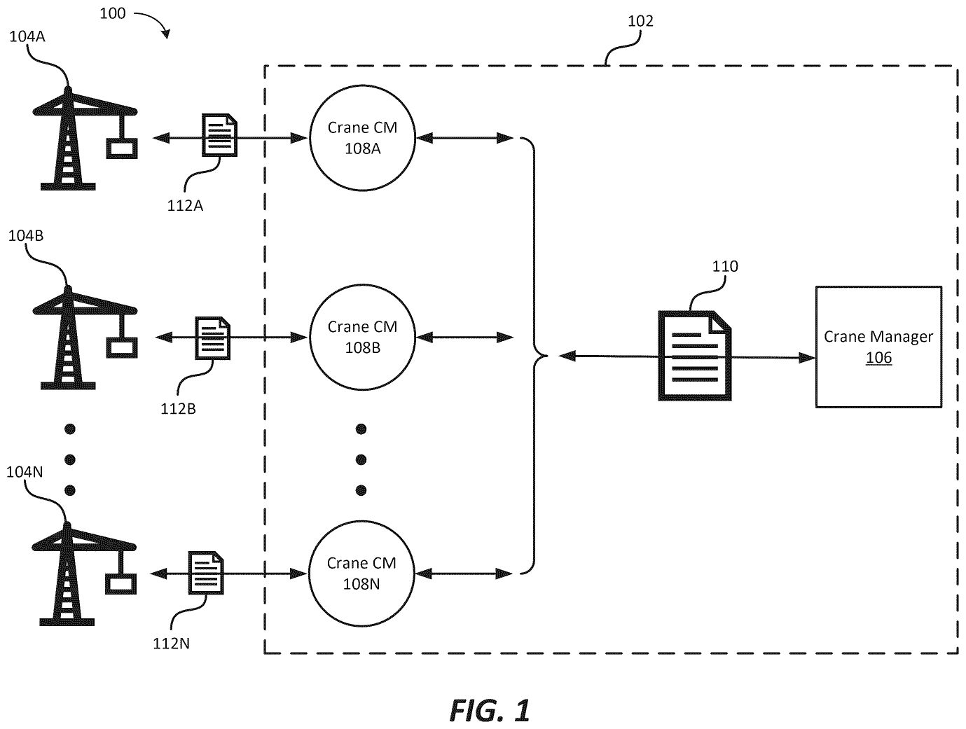

An example of this architecture will now be described with respect to FIG. 1, which illustrates an example process for controlling automation equipment in a materials handling system 100, according to the present teachings. As shown in FIG. 1, the materials handling system 100 includes a WES 102 and a plurality of automation devices 104A-104N. In the illustrated example of FIG. 1, the automation devices 104A-104N are shown and described as crane equipment (e.g., cranes). However, persons skilled in the art should understand that in other examples, the automation devices 104A-104N can be implemented using other types of automation equipment (e.g., shuttles, lifts, conveyor, etc.). Moreover, the materials handling system 100 can include additional automation devices not explicitly shown or described herein. Hereinafter, the automation devices 104A-104N can be referred to as the cranes 104A-104N and/or the cranes 104.

As shown in FIG. 1, the WES 102 includes a crane manager 106 and a plurality of crane CMs 108A-108N. Each crane CM 108 can be used to translate universal commands from the crane manager 106 into commands formatted in the equipment-level language of cranes 104 sourced from respective vendors. For example, the first crane CM 108A can translate a universal command output by the crane manager 106 into a vendor-specific command formatted in the equipment-level language of cranes 104A sourced from a first vendor. As another example, the second crane CM 108B can translate a universal command output by the crane manager 106 into a vendor-specific command formatted in the equipment-level language of cranes 104B sourced from a second vendor. Similarly, the Nth crane CM 108N can translate a universal command output by the crane manager 106 into a vendor-specific command formatted in the equipment-level language of cranes 104N sourced from an Nth vendor.

In operation, the WES 102 may receive a request to perform a command that involves the use of one or more cranes 104. For example, the WES 102 may receive a request to store pallets in long-term storage racks. In response to receiving this request, the WES 102 uses the crane manager 106 to generate a set of universal instructions 110 (e.g., depicted by a text file) for controlling one or more cranes 104 to perform an action such as, but not limited to, storing a pallet in long-term storage. This set of universal instructions 110 is then detected and translated by the crane CMs 108A-108N into respective sets of instructions 112A-112N formatted in equipment-level languages specific to the cranes 104A-104N.

For example, a crane CM 108A associated with a first vendor detects and translates the set of universal instructions 110 into a first set of instructions 112A that is understood by cranes 104A manufactured by the first vendor. In this example, one or more first cranes 104A can then perform the action in accordance with the first set of instructions 112A. As another example, a crane CM 108B associated with a second vendor detects and translates the set of universal instructions 110 into a second set of instructions 112B that is understood by cranes 104B manufactured by the second vendor. In this example, one or more second cranes 104B can then perform the action in accordance with the second set of instructions 112B. As another example, a crane CM 108N associated with an Nth vendor detects and translates the set of universal instructions 110 into an Nth set of instructions 112N that is understood by cranes 104N manufactured by the Nth vendor. In this example, one or more Nth cranes 104N can then perform the action in accordance with the Nth set of instructions 112N.

It should be understood that the illustrated example of FIG. 1 is non-limiting. In that regard, although the illustrated example of FIG. 1 is shown and described with respect to cranes, it should be understood that functionality described with respect to the managers and communication microservices shown in FIG. 1 can be applied to automation devices and/or equipment other than cranes (e.g., shuttles, GTP devices, conveyors, etc.).

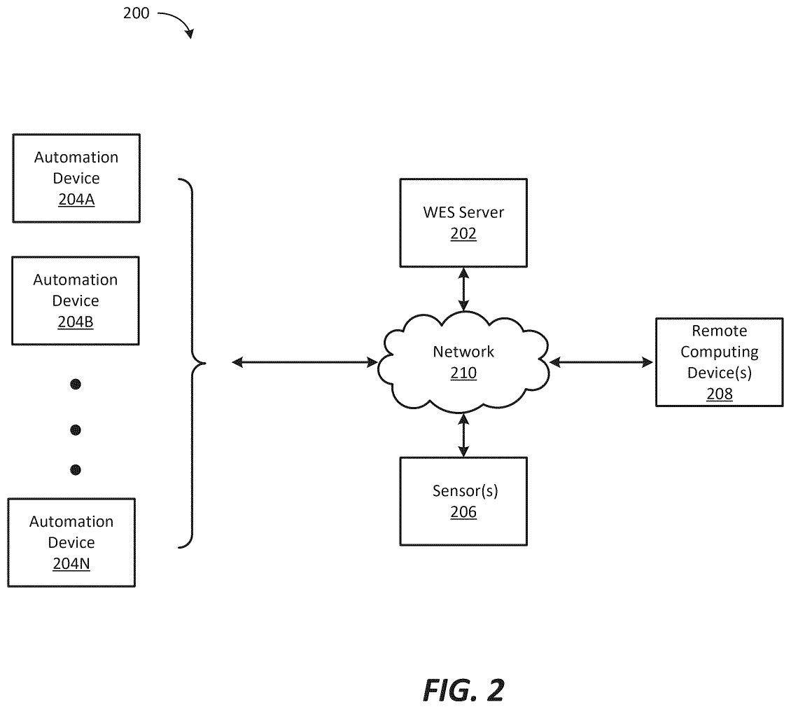

FIG. 2 illustrates an example materials handling system 200, according to the present teachings. The materials handling system 200 can be, for example, similar in construction to and/or implemented using the materials handling system 100 of FIG. 1. As shown, the materials handling system 200 includes a WES server 202, a plurality of automation devices 204A-204N, one or more sensors 206, and one or more remote computing devices 208, each of which are connected via a communications network 210.

The communications network 210 can be, for example, a combination of one or more of a wide area network (WAN) (e.g., the Internet, a TCP/IP based network, a cellular network, such as, for example, a Global System for Mobile Communications [GSM] network, a General Packet Radio Services [GPRS] network, a Code Division Multiple Access [CDMA] network, an Evolution-Data Optimized [EV-DO] network, an Enhanced Data Rates for GSM Evolution [EDGE] network, a 3 GSM network, a 4GSM network, a Digital Enhanced Cordless Telecommunications [DECT] network, a Digital AMPS [IS-136/TDMA] network, or an Integrated Digital Enhanced Network [iDEN] network, etc.), a local area network (LAN), a neighborhood area network (NAN), a home area network (HAN), and/or a personal area network (PAN) employing any of a variety of communications protocols, such as Wi-Fi, Bluetooth, ZigBee, etc.

The WES server 202 can be, for example, similar in construction to and/or implemented using the WES 102 of FIG. 1. As will be described in more detail herein, the WES server 202 is adapted to control the one or more automation devices 204A-204N (e.g., pieces of automation equipment) to move products (e.g., goods, materials, packages, pallets, consumer products, etc.) through a distribution center and/or warehouse. The automation devices 204A-204N can include any suitable type of automation equipment such as, but not limited to, conveyors, shuttles, lifts, cranes, ASRS devices, pick lights, projectors, user-interfaces, robotic arms, and/or other devices. In some examples, the automation devices 204A-204N can be, for example, similar in construction to and/or implemented using the automation devices (e.g., cranes) 104A-104N.

In operation, the WES server 202 can control the automation devices 204A-204N using various managers and communication microservices. For example, if the automation device 204A is a crane sourced from a first vendor, the WES server 202 can control the automation device 204A using a universal crane manager and a crane CM specific to the first vendor. As another example, if the automation device 204B is a crane sourced from a second vendor, the WES server 202 can control the automation device 204B using the universal crane manager and a crane CM specific to the second vendor. As another example, if the automation device 204C is a shuttle sourced from a first vendor, the WES server 202 can control the automation device 204C using a universal shuttle manager and a shuttle CM specific to the first vendor. Likewise, if the automation device 204D is a shuttle sourced from the first vendor, the WES server 202 can control the automation device 204D using the universal shuttle manager and the shuttle CM specific to the first vendor. However, if the automation device 204E is a shuttle sourced from a third vendor, the WES server 202 can control the automation device 204E using the universal shuttle manager and a shuttle CM specific to the third vendor.

The one or more sensors 206 can be adapted to monitor and generate data indicative of the operation of one or more of the automation devices 204A-204N included in the materials handling system 200. For example, the one or more sensors 206 can generate data indicative of one or more operating parameters (e.g., temperature, power consumption, voltage, operating state, position, fault status, etc.) associated with an automation device 204 and the WES server 202 can determine, based on the data generated by the one or more sensors 206, whether an automation device 204 is operating as expected, whether an automation device 204 has experienced a fault, whether an automation device is damaged, whether an automation device 204 has experienced a failure, and/or some other information associated with the automation device 204. In some examples, the one or more sensors 206 can include one or more of leak sensors, photoeye sensors, voltage sensors, torque sensors, temperature sensors, contact sensors, magnetic sensors, and/or one or more other types of sensors.

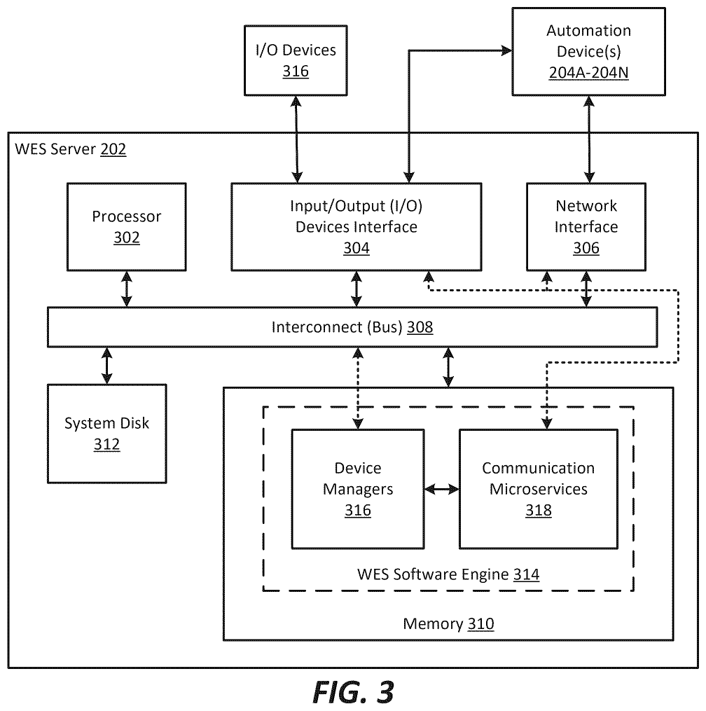

FIG. 3 is a block diagram of an example WES server 202 included in the materials handling system 200, according to the present teachings. The WES server 202 can be implemented using one or more of a local server, a remote server, a cloud server, a collections of servers, a cloud-based computing system, a programmable logic controller (PLC), and/or any other suitable computing device. As shown in FIG. 3, the WES server 202 includes, without limitation, a processor 302, an input/output (I/O) devices interface 304, a network interface 306, an interconnect 308, a system memory 310, and a system disk 312. The interconnect, or bus, 308 can include one or more wires, cables, traces, contacts, analog components, digital components, wireless connection components, and/or other suitable means for interconnecting hardware components of the WES server 202.

The processor 302 is adapted to retrieve and execute programming instructions, such as the WES software engine 314. Similarly, the processor 302 is adapted to store application data (e.g., software libraries) in and retrieve application data from the system memory 310. The interconnect 308 is adapted to facilitate transmission of data, such as programming instructions and application data, between the processor 302, the I/O devices interface 304, the network interface 306, the system memory 310, and the system disk 312. In some examples, the interconnect 308 includes and/or is implemented using a data streaming platform that functions as a central data bus (e.g., Apache Kafka®, Amazon Kinesis®, RabbitMQ, etc.). In such examples, the data streaming platform included in and/or implemented as the interconnect 308 allows for data streams between the WES software engine 314, the components of WES server 202, and the automation devices 204A-204N to be processed continuously with high-throughput.

The I/O devices interface 304 is adapted to receive input data from I/O devices 316 and transmit the input data to the processor 302 via the interconnect 308. For example, I/O devices 316 may include one or more buttons, a keyboard, a mouse, one or more automation devices, and/or other input devices. The I/O devices interface 304 is further adapted to receive output data from the processor 302 via the interconnect 308 and transmit the output data to the I/O devices 316. In some examples, the I/O devices interface 304 provides and interface through which the WES software engine 314 can connect to and/or control the automation devices 204A-204N. In such examples, instructions for controlling one or more automation devices 204A-204N can be transmitted from the WES software engine 314 to the automation devices 204A-204N via the interconnect 308 and/or the I/O devices interface 304.

In some examples, the WES software engine 314 can communicate with and/or control the automation devices 204A-204N using the network interface 306. For example, the WES software engine 314 can transmit instructions for controlling the automation devices 204A-204N over communications network 210 via the network interface 306. That is, the WES software engine can transmit instructions over the communications network 210 to the automation devices 204A-204N via the interconnect 308 and the network interface 306.

The system disk 312 may include one or more hard disk drives, solid state storage devices, or similar storage devices. The system disk is adapted to store non-volatile data such as files (e.g., audio files, video files, subtitles, application files, software libraries, etc.). For example, the system disk 312 is adapted to store one or more automation device managers and/or automation device communication microservices.

As shown, the system memory 310 includes the WES software engine 314. The WES software engine 314, which can be implemented as one or more of an operating system, application software, firmware, database software, etc., comprises the core logic and functionality of the WES. In that regard, the processor 302 executes the WES software engine 314 to receive requests (e.g., orders received from business logic, requests received from remote computing devices, etc.) and fulfill the received request by controlling one or more automation devices 204A-204N. In some examples, the WES software engine 314 is similar in operation to and/or implemented using the WES 102 of FIG. 1.

The WES software engine 314 includes one or more automation device managers 316 adapted for controlling the automation devices 204A-204N. The automation device managers 316, which may hereinafter simply be referred to as “managers” 316, can be, for example, similar in operation to and/or implemented using the managers 106 described herein with respect to FIG. 1. In some examples, the WES software engine 314 includes one manager 316 per type of automation device included in the materials handling system 200. For example, if automation devices 204A-204N include conveyor equipment, shuttles, and cranes, the WES software engine 314 will include one or more conveyor managers 316, one or more shuttle managers 316, and one or more crane managers 316. As described herein, the managers 316 are adapted to generate universal, or vendor-agnostic, commands for controlling the respective automation devices 204A-204N. In that regard, a conveyor manager 316 generates universal commands for controlling conveyor equipment included in the automation devices 204A-204N. Similarly, a shuttle manager 316 generates universal commands for controlling shuttles included in the automation devices 204A-204N and a crane manager 316 generates universal commands for controlling cranes included in the automation devices 204A-204N.

In some examples, the managers 316 are separate software components from the WES software engine 314. In other examples, the managers 316 are integrated within the WES software engine 314. The managers 316 can be implemented as one or more of blocks of code comprised in the WES software engine 314, packages of software instructions, individual software applications, software modules, and/or any other suitable structure of computer programmable instructions for generating universal, device agnostic commands.

As further shown in the illustrated example of FIG. 3, the WES software engine 314 includes one or more device communication microservices 318. As described herein, the automation device communication microservices 318, or simply the “communication microservices,” are adapted to detect universal, vendor-agnostic commands generated by a manager 316 and generated, based in part one these translate these universal, vendor-agnostic commands, vendor-specific commands (e.g., commands formatted in the language of the particular device) for controlling a particular automation device 204. In this regard, the system memory 310 can store and/or the WES software engine 314 can include one or more respective communication microservices 318 for each type and/or vendor of automation device 204 included in the materials handling system 200.

For example, if the materials handling system 200 includes cranes sourced from a first vendor, cranes sourced from a second vendor, and cranes sourced from a third vendor, the system memory 310 can store and/or the WES software engine 314 can include a first communication microservice 318 for cranes sourced from the first vendor, a second communication microservice 318 for cranes sourced from the second vendor, and a third communication microservice 318 for cranes sourced from the third vendor. As another example, if the materials handling system 200 includes cranes sourced from a first vendor, shuttles sourced from the first vendor, and conveyors sourced from a second vendor, the system memory 310 can store and/or the WES software engine 314 can include a respective communication microservice 318 for cranes sourced from the first vendor, a respective communication microservice 318 for shuttles sourced from the first vendor, and a respective communication microservice 318 for conveyors sourced from the second vendor.

In some examples, the communication microservices 318 are separate software components from the WES software engine 314. In other examples, the communication microservices 318 are integrated within the WES software engine 314. The communication microservices 318 can be implemented as one or more of blocks of code comprised, packages of software instructions, individual software applications, software modules, and/or any other suitable structure of computer programmable instructions for translating universal, device agnostic commands into vendor-specific commands. Hereinafter, the communication microservices 318 can be referred to as “CMs 318.”

As shown in FIG. 3, in some examples, the CMs 318 are connected directly, via the I/O devices interface 304 and/or the network interface 306, to the automation devices 204A-204N without use of the interconnect 308. In such examples, when a CM 318 generates and transmits a vendor-specific command to the a respective automation device 204, the vendor-specific command does not transmit through the interconnect 308. Rather, as shown, the vendor-specific command can be transmitted directly from the CM 318 to the respective automation device 204 via the I/O devices interface 304 and/or the network interface 306. In that regard, the CM 318 can communicate directly with the automation device 204 using whichever protocol (e.g., TCP/IP, PLC Tag, Rest, etc.) that automation device 204 uses to communicate.

When compared to a manager 316, the data size of a respective CM 316 can be made relatively small. Furthermore, as described herein, CMs 318 can be easily modified and/or added to the WES software engine 314 after the WES software engine 314 has been deployed in a materials handling system 200. When a new automation device 204 is added to the materials handling system 200 and a CM 318 for that new automation device 204 is not currently stored in the system memory 310 and/or included in the WES software engine 314, a new CM 318 for that new automation device 204 can be added to the WES software engine 314 and/or system memory 310. In that regard, a newly added CM 318 can be implemented in conjunction with the WES software engine 314 without having to modify the core logic of WES software engine 314.

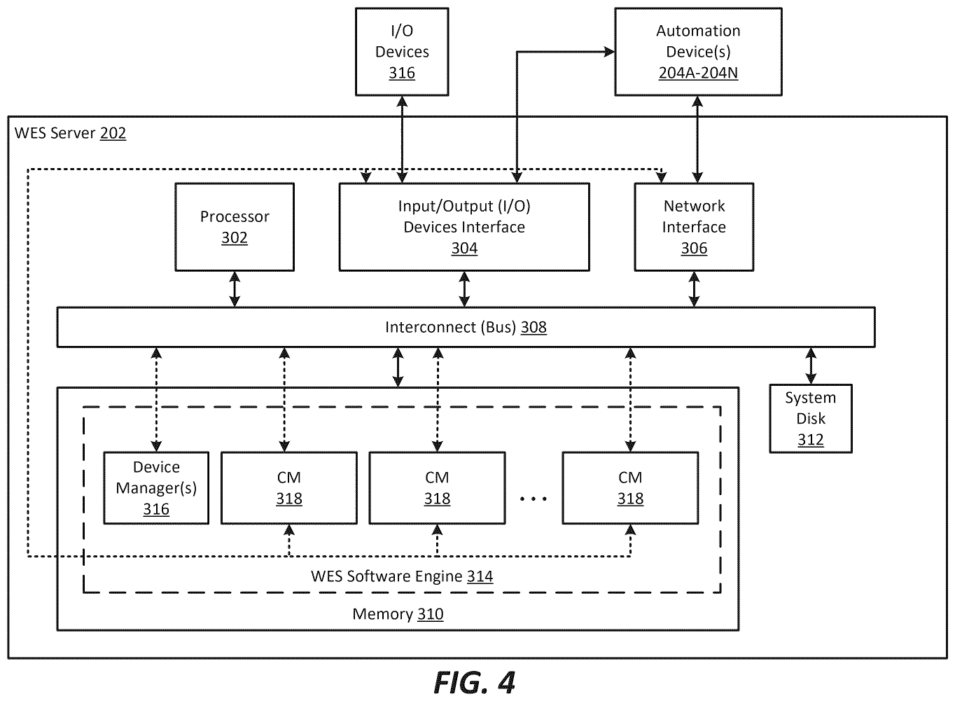

In the illustrated example of FIG. 3, the managers 316 included in the WES software engine 314 and the CMs 318 included in the WES software engine 314 are shown to be in direct communication with each other within the system memory 310. However, in other examples, a manager 316 can communicate with one or more CMs 318 over the interconnect 308. FIG. 4 is a block diagram of another example WES server 202 included in the materials handling system 200, according to the present teachings. In the illustrated example of FIG. 4, the manager(s) 316 included in the WES software engine 314 are connected to and/or communicate with the CMs 318 via the interconnect 308. As described herein, the interconnect 308 can be implemented as, for example, an Apache KAFKA®bus.

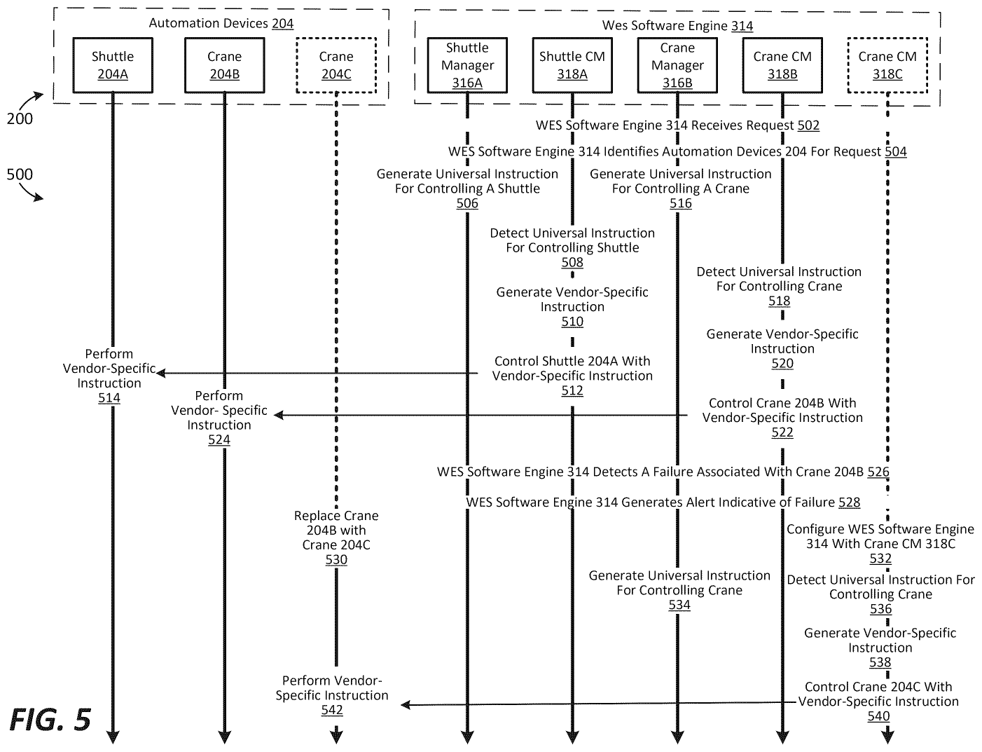

FIG. 5 is an example flow diagram of a process 500 for operating a materials handling system in conjunction with a WES, according to the present teachings. For example, FIG. 5 is an example flow diagram of a process 500 for operating the materials handling system 200 in conjunction with the WES software engine 314. Although the interaction between the devices in process 500 are shown in an order, persons skilled in the art will understand that the interactions may be performed in a different order, interactions may be repeated or skipped, and/or may be performed by components other than those described in FIG. 5. Moreover, the process 500 may include additional interactions and/or steps that are not explicitly shown and/or described herein.

In the illustrated example of FIG. 5, the materials handling system 200 is shown as including a plurality of automation devices 204. At the time process 500 begins, the plurality of automation devices 204 includes a shuttle 204A sourced from a first vendor and a crane 204B sourced from a second vendor. As will be described herein, a crane 204C sourced from a third vendor (represented with dashed lines) is added to the materials handling system 200 during the process 500. Persons skilled in the art should understand the automation devices 204 illustrated in FIG. 5 are provided as non-limiting examples, and that in other examples, additional and/or different automation devices 204 can be included in the materials handling system 200 and used to implement the process 500.

As further shown in the illustrated example of FIG. 5, the materials handling system 200 includes the WES software engine 314. The WES software engine 314 is, for example, executed on the WES server 202 and connected to the automation devices 204 via the communications network 210. The WES software engine 314 includes a shuttle manager 316A, a shuttle CM 318A for controlling shuttles sourced from the first vendor, a crane manager 316B, and a crane CM 318B for controlling cranes sourced from the second vendor. As will be described herein, a crane CM 318C (represented with dashed lines) used for controlling cranes sourced from a third vendor is added to the WES software engine 314 during the process 500. Persons skilled in the art should understand the managers 316 and the CMs 318 illustrated in FIG. 5 are provided as non-limiting examples, and that in other examples, additional and/or different managers 316 and/or CMs can be included in the WES software engine 314 and used to implement the process 500.

Process 500 begins at step 502 where the WES software engine 314 receives a request associated with the materials handling system 200. For example, the WES software engine 314 receives a request to store a pallet loaded with product. The WES software engine 314 can receive the request from, for example, business logic running on the WES server 202 and/or a remote computing device 208.

At step 504, the WES software engine 314 identifies which automation devices 204 are needed to service the request. For example, the WES software engine 314 identifies that a shuttle (e.g., the shuttle 204A) and a crane (e.g., the crane 204B) are needed to service the request for storing a pallet.

At step 506, the WES software engine 314 uses the shuttle manager 316A to generate a universal instruction (e.g., command) for controlling a shuttle to service the request. For example, the shuttle manager 316A generates a universal instruction for controlling a shuttle to store the pallet (e.g., perform one or more steps in a pallet storage process). In some examples, the shuttle manager 316A publishes the universal instruction for controlling the shuttle for discovery by one or more shuttle CMs 318.

At step 508, the shuttle CM 318A detects the universal instruction for controlling a shuttle. For example, the shuttle CM 318A discovers the universal instruction for controlling a shuttle following the universal instruction being published by the shuttle manager 316A. In some examples, the shuttle CM 318A detects the universal instruction for controlling a shuttle on the interconnect 308, where the interconnect 308 is a data streaming platform that functions as a central data bus (e.g., Apache Kafka®, Amazon Kinesis®, RabbitMQ, etc.).

At step 510, the shuttle CM 318A generates, based in part on the universal instruction, a vendor-specific instruction for controlling the shuttle 204A sourced from the first vendor. For example, the shuttle CM 318A translates the universal instruction for controlling a shuttle into a vendor-specific command that is formatted in a language specific to shuttles (e.g., shuttle 204A) sourced from the first vendor.

At step 512, the shuttle CM 318A controls the shuttle 204A with the vendor-specific instruction. For example, the shuttle CM 318A controls the shuttle 204A to store a pallet with the vendor-specific instruction. In some examples, the shuttle CM 318A transmits the vendor-specific instruction to the shuttle 204A using the I/O devices interface 304 and/or the network interface 306.

At step 514, the shuttle 204A performs the vendor-specific instruction. For example, the shuttle 204A stores the pallet (e.g., performs one or more steps in a pallet storage process) in accordance with the vendor-specific instruction. In this example, the shuttle 204A can move the pallet to a location at which the crane 204B can transfer the pallet from the shuttle 204A onto a storage rack in accordance with the vendor-specific instruction.

At step 516, the WES software engine 314 uses the crane manager 316B to generate a universal instruction for controlling a crane to service the request. For example, the crane manager 316B generates a universal instruction for controlling a crane to store the pallet (e.g., perform one or more steps in a pallet storage process). In some examples, the crane manager 316B publishes the universal instruction for controlling the crane for discovery by one or more crane CMs 318.

At step 518, the crane CM 318B detects the universal instruction for controlling a crane. For example, the crane CM 318B discovers the universal instruction for controlling a crane following the universal instruction being published by the crane manager 316B. In some examples, the crane CM 318B detects the universal instruction for controlling a shuttle on the interconnect 308, where the interconnect 308 is a data streaming platform that functions as a central data bus (e.g., Apache Kafka®, Amazon Kinesis®, RabbitMQ, etc.).

At step 520, the crane CM 318B generates, based in part on the universal instruction for controlling a crane, a vendor-specific instruction for controlling the crane 204B sourced from a second vendor. For example, the crane CM 318B translates the universal instruction for controlling a crane into a vendor-specific command that is formatted in a language specific to cranes (e.g., crane 204B) sourced from the second vendor.

At step 522, the crane CM 318B controls the crane 204B with the vendor-specific instruction. For example, the crane CM 318B controls the crane 204B to store a pallet with the vendor-specific instruction. In some examples, the crane CM 318B transmits the vendor-specific instruction to the crane 204B using the I/O devices interface 304 and/or the network interface 306.

At step 524, the crane 204B performs the vendor-specific instruction. For example, the crane 204B stores the pallet (e.g., performs one or more steps in a pallet storage process) in accordance with the vendor-specific instruction. In this example, the crane 204B can transfer the pallet from the shuttle 204A onto a storage rack in accordance with the vendor-specific instruction.

At step 526, the WES software engine 314 detects a failure associated with the crane 204B. For example, the WES software engine 314 receives sensor data from one or more of the sensors 206 and determines, based on the sensor data, that the crane 204B has experienced a failure (e.g., damaged component, loss of function, etc.). At step 528, the WES software engine 314 generates an alert indicative of the failure associated with the crane 204B. For example, the WES software engine 314 generates and transmits the alert to a remote computing device 208 associated with maintenance personnel.

At step 530, the crane 204B is replaced with a new crane 204C sourced from a third vendor. The third vendor from which the new crane 204C was sourced is different from the second vendor from which the crane 204B was sourced.

At step 532, the WES software engine 314 is configured with a crane CM 318C that can be used to control cranes sourced from a third vendor. In some examples, the WES software engine 314 was previously configured with the crane CM 318C. In some examples, the WES software engine 314 determines whether it has been configured with a crane CM capable of controlling cranes sourced from a third vendor before being configured with the crane CM 318C.

At step 534, the WES software engine 314 uses the crane manager 316B to generate a universal instruction for controlling a crane to service a request. For example, the crane manager 316B generates a universal instruction for controlling a crane to retrieve a pallet from storage (e.g., perform one or more steps in a pallet retrieval process). In some examples, the crane manager 316B publishes the universal instruction for controlling the crane for discovery by one or more crane CMs 318.

At step 536, the crane CM 318C detects the universal instruction for controlling a crane. For example, the crane CM 318C discovers the universal instruction for controlling a crane following the universal instruction being published by the crane manager 316B. In some examples, the crane CM 318C detects the universal instruction for controlling a shuttle on the interconnect 308, where the interconnect 308 is a data streaming platform that functions as a central data bus (e.g., Apache Kafka®, Amazon Kinesis®, RabbitMQ, etc.).

At step 538, the crane CM 318C generates, based in part on the universal instruction for controlling a crane, a vendor-specific instruction for controlling the crane 204C sourced from a third vendor. For example, the crane CM 318C translates the universal instruction for controlling a crane into a vendor-specific command that is formatted in a language specific to cranes (e.g., crane 204C) sourced from the third vendor.

At step 540, the crane CM 318C controls the crane 204C with the vendor-specific instruction. For example, the crane CM 318C controls the crane 204C to retrieve a pallet with the vendor-specific instruction. In some examples, the crane CM 318C transmits the vendor-specific instruction to the crane 204C using the I/O devices interface 304 and/or the network interface 306.

At step 542, the crane 204C performs the vendor-specific instruction. For example, the crane 204C retrieves the pallet (e.g., performs one or more steps in a pallet retrieval process) in accordance with the vendor-specific instruction. In this example, the crane 204C can transfer the pallet from a storage rack onto a shuttle in accordance with the vendor-specific instruction.

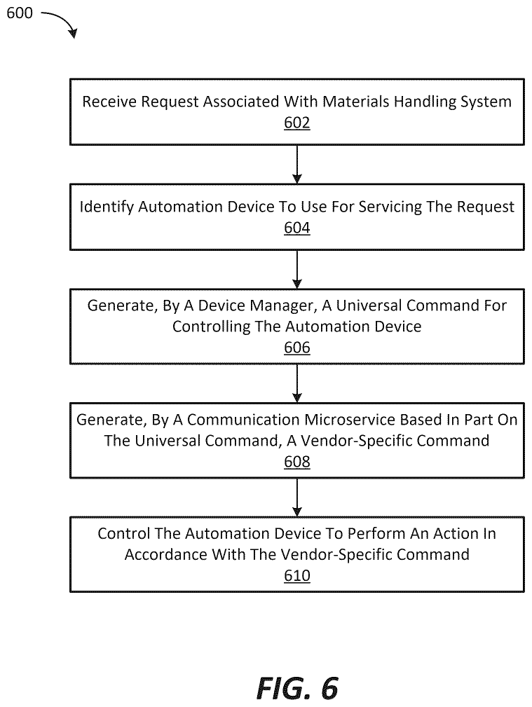

FIG. 6 is a flow diagram of method steps for controlling a materials handling system with a WES, according to the present teachings. For example, FIG. 6 is a flow diagram of method steps for controlling one or more automation devices 204 included in the materials handling system 200 with the WES software engine 314, according to the present teachings. Although the method steps are described in conjunction with the systems of FIGS. 1-5, persons skilled in the art will understand that nay system configured to perform the method steps, in any order, is within the scope of the present disclosure.

As shown, a method 600 begins at step 602, at which a request associated with the materials handling system is received. For example, the WES software engine 314 running on the WES server 202 receives a request associated with the materials handling system 200. A request associated with the materials handling system 200 can include, without limitation one or more of a request to pick an order, a request to store an order, a request to retrieve an order from storage, a request to transfer a pallet, a request to store a pallet, a request to retrieve a pallet, a request to ship an order, and/or any other suitable request. In some examples, the WES software engine 314 receives the request from the business logic running on the WES server 202 or from a remote computing device 208.

At step 604, an automation device that can be used to service the request is identified. For example, the WES software engine 314 running on the WES server 202 identifies an automation device 204 that can be used to service the request. For an example in which the request is a request to store a pallet, the WES software engine 314 may identify a crane and/or a shuttle included in the automation devices 204 to use for servicing the request. For an example in which the request is a request to pick an order, the WES software engine 314 may identify one or more components of a goods-to-person system (e.g., conveyor, pick light, projector, shuttle, etc.) that can be used to pick an order. In some examples, more than one automation device 204 is identified at step 604.

At step 606, a device manager is used to generate a universal command for controlling the automation device. For example, the WES software engine 314 running on the WES server 202 uses a device manager 316 associated with the type of the automation device 204 identified at step 604 to generate a universal command for controlling the automation device. As an example, if the automation device 204 identified at step 604 is a crane, the WES software engine 314 uses a device manager 316 associated with cranes (e.g., crane manager) to generate the universal command for controlling the automation device 204. For examples in which more than one automation device 204 is identified at step 604, the WES software engine 314 can use respective device managers 316 for each type of automation device 204 identified at step 604 (e.g., use a crane manager to generate a universal command for controlling a crane, use a conveyor manager to generate a universal command for controlling a conveyor, etc.).

At step 608, a communication microservice is used to generate a vendor-specific command based on the universal command. For example, the WES software 314 running on the WES server 202 includes and/or implements a CM 318 associated with the vendor of the automation device 204 that is adapted to generate a vendor-specific command for controlling the automation device 204. As an example, if the automation device 204 identified at step 604 is sourced from a first vendor, a CM 318 associated with the first vendor translates the universal command into a vendor-specific command for controlling the automation device 204. As another example, if the automation device 204 identified at step 604 is sourced from a second vendor, a CM 318 associated with the second vendor translates the universal command into a vendor-specific command for controlling the automation device 204. As described herein, a “vendor-specific” command is a command that is in a format and/or language specific to the vendor of the automation device 204.

In some examples, the WES software engine 314 includes a plurality of CMs 318. In such examples, the CM 318 associated with the vendor from which the automation device 204 is sourced detects and translates the universal command output by the device manager 316 into a vendor-specific command for controlling the automation device 204. In some examples, the WES software engine 314 selects, from a plurality of CMs 318, the CM 318 that corresponds to the type and vendor of the automation device 204.

At step 610, the automation device is controlled to perform an action based in part on the vendor-specific command generated by the communication microservice. For example, the automation device 204 performs one or more actions in accordance with the vendor-specific command generated by the CM 318. For an example in which the automation device 204 is a shuttle, the shuttle travels in accordance with the vendor-specific generated by the CM 318.

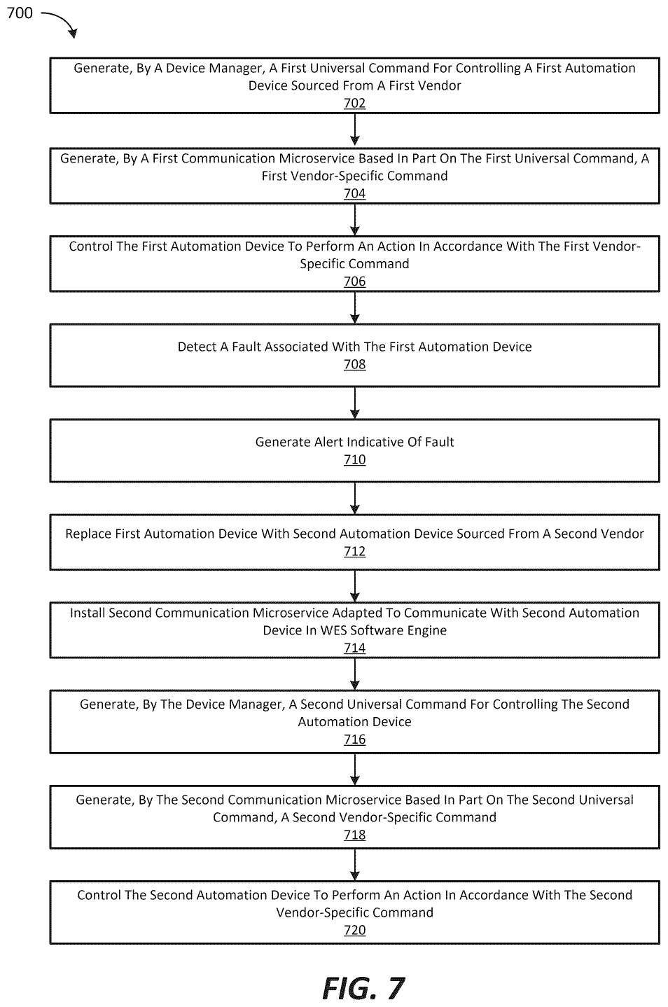

FIG. 7 is a flow diagram of method steps for replacing an automation device in a materials handling system, according to the present teachings. For example, FIG. 7 is a flow diagram of method steps for replacing an automation device 204 included in the materials handling system 200, according to the present teachings. Although the method steps are described in conjunction with the systems of FIGS. 1-5, persons skilled in the art will understand that nay system configured to perform the method steps, in any order, is within the scope of the present disclosure.

As shown, a method 700 begins at step 702, at which a device manager generates a first universal command for controlling a first automation device sourced from a first vendor. For example, the WES software engine 314 running on the WES server 202 uses a device manager 316 to generate a first universal command for controlling a first automation device 204 sourced from a first vendor. The first automation device 204 can be implemented as, for example, a crane, a shuttle, a conveyor, a lift, and/or any other suitable type of automation device included in the materials handling system 200.

At step 704, a first communication microservice associated with the first vendor generates, based in part on the first universal command, a first vendor-specific command for controlling the first automation device. For example, a first CM 318 associated with the first vendor translates, based in part on a format associated with the first vendor, the first universal command into a first vendor-specific command for controlling the first automation device 204.

At step 706, the first automation device is controlled to perform an action based in part on the first vendor-specific command generated by the first communication microservice. For example, the first automation device 204 performs one or more actions in accordance with the first vendor-specific command generated by the first CM 318.

At step 708, a fault associated with the first automation device is detected. For example, the WES software engine 314 detects a fault (e.g., overcurrent, fault status, damage, component failure, loss of power, etc.) associated with the first automation device 204 based in part on data received from one or more sensors 206.

At step 710, an alert indicative of the fault is generated. For example, the WES software engine 314 generates an alert indicative of the fault associated with the first automation device 204. In some examples, the WES software engine 314 transmits the alert to a remote computing device 208 associated with maintenance personnel.

At step 712, the first automation device is replaced with a second automation device sourced from a second, different vendor. For example, maintenance personnel replaces the first automation device 204, which was sourced form a first vendor, with a second automation device 204 sourced from a second vendor. As an example, if the first automation device 204 is a crane sourced from a first vendor, the first automation device 204 is replaced with a second crane sourced from a second, different vendor. As another example, if the first automation device 204 is a shuttle sourced from a first vendor, the first automation device 204 is replaced with a second shuttle sourced from a second, different vendor.

At step 714, a second communication microservice adapted to communicate with the second automation device sourced from the second vendor is installed and/or integrated with the WES. For example, a second CM 318 associated with the second vendor is installed and/or integrated in the WES software engine 314.

At step 716, the same device manager from step 702 generates a second universal command for controlling the second automation device. For example, the WES software engine 314 running on the WES server 202 uses the same device manager 316 to generate a second universal command for controlling the second automation device 204 that replaced the first automation device 204.

At step 718, a second communication microservice associated with the second vendor generates, based in part on the second universal command, a second vendor-specific command for controlling the second automation device. For example, a second CM 318 associated with the second vendor translates, based in part on a format associated with the second vendor, the second universal command into a second vendor-specific command for controlling the second automation device 204.

At step 720, the second automation device is controlled to perform an action based in part on the second vendor-specific command generated by the second communication microservice. For example, the second automation device 204 performs one or more actions in accordance with the second vendor-specific command generated by the second CM 318 associated with the second vendor.

In some examples, the materials handling system 200 includes a goods-to-person (GTP) system. In such examples, similar to control of the automation devices 204 described herein, the WES software engine 314 can use one or more managers 316 and communication microservices 318 to control the components included in the GTP system. In some examples, the individual components of the GTP system and/or the GTP system itself can be implemented as the automation devices 204 included in the materials handling system 200. In that regard, any description herein related to using a WES software engine 314 to control an automation device 204 is also applicable to using a WES software engine 314 to control a component and/or a combination of components included in a GTP system. Similarly, any description herein related replacing an automation device 204 is also applicable to replacing a component included in a GTP system. Moreover, the processes and methods described with respect to FIGS. 5-77 can also be implemented with one or more components of a GTP system.

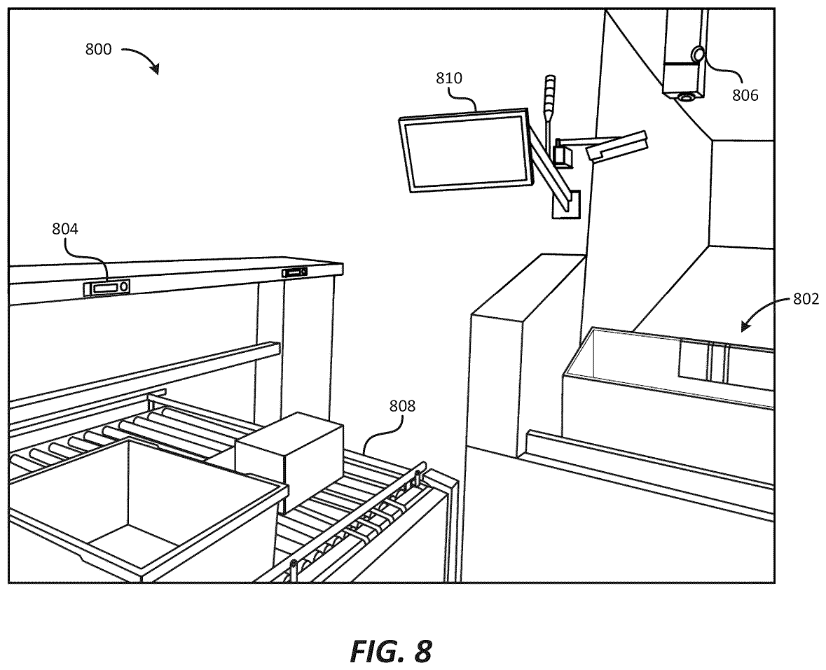

FIG. 8 illustrates an example GTP system 800, according to the present teachings. The GTP system 800 can be operated in conjunction with and/or controlled by the WES software engine 314. In some examples, the GTP system 800 can be implemented as one or more of the automation devices 204 included in the materials handling system 200. As shown, the GTP system 800 includes an automated storage and retrieval system (ASRS) 802, a pick light 804, a projector 806, a conveyor 808, and a user-interface (UI) 810. Although not shown in FIG. 8, each of the components included in the GTP system 800 are in electrical communication with the WES server 202 (and the WES software engine 314) via the communications network 210.

The components included in the GTP system 800 can be sourced from a single vendor or one or more different vendors. In some examples, the one or more of the components included in the GTP system 800 are sourced from the same vendor. In some examples, each component included in the GTP system 800 is sourced from a different vendor. In operation, the WES server 202 receives a pick order from a remote computing device (e.g., a remote computing device 208 operated by an online retailer, the operator of the distribution center in which the GTP system 800 is installed, etc.). In response to receiving the pick order, the WES software engine 314 running on the WES server 202 generates universal, vendor-agnostic commands for controlling the components of the GTP system 800 to service the pick order.

In one example, the ASRS 802 is sourced from a first vendor (e.g., Vendor 1), the pick light 804 is sourced from a second vendor (e.g., Vendor 2), the projector 806 is sourced from a third vendor (e.g., Vendor 3), the conveyor 808 is sourced from a fourth vendor (e.g., Vendor 4), and the UI 810 is sourced from a fifth vendor (e.g., Vendor 5).

In this example, the WES software engine 314 implements an ASRS manager 316 (e.g., a manager of the robotic fleet/ASRS) to generate and publish universal commands for controlling the ASRS 802 to service the pick order. In addition, the WES software engine 314 includes and/or implements a first ASRS CM 318 that is adapted to control the ASRS 802 sourced from Vendor 1. The first ASRS CM 318 can detect a universal command generated by the ASRS manager 316 and translate the universal command into a vendor-specific command that is formatted in the language specific to an ASRS sourced from Vendor 1. The ASRS 802 can then be controlled in accordance with the vendor-specific command to service the pick order (e.g., perform one or more steps in the process of servicing the pick order). For instances in which the ASRS 802 is replaced with a new ASRS sourced from a different vendor, the WES software engine 314 is modified to include and/or implement a second ASRS CM 318 that is adapted to control an ASRS sourced from the different vendor.

Further in this example, the WES software engine 314 implements a pick light manager 316 to generate and publish universal commands for controlling the pick light 804 to service the pick order. In addition, the WES software engine 314 includes and/or implements a first pick light CM 318 that is adapted to control the pick light 804 sourced from Vendor 2. The first pick light CM 318 can detect a universal command generated by the pick light manager 316 and translate the universal command into a vendor-specific command that is formatted in the language specific to pick lights sourced from Vendor 2. The pick light 804 can then be controlled in accordance with the vendor-specific command to service the pick order (e.g., perform one or more steps in the process of servicing the pick order). For instances in which the pick light 804 is replaced with a new pick light sourced from a different vendor, the WES software engine 314 is modified to include and/or implement a second pick light CM 318 that is adapted to control a pick light sourced from the different vendor.

Further in this example, the WES software engine 314 implements a projector manager 316 to generate and publish universal command for controlling the projector 806 to service the pick order. In addition, the WES software engine 314 includes and/or implements a first projector CM 318 that is adapted to control the projector 806 sourced from Vendor 3. The first projector CM 318 can detect a universal command generated by the projector manager 316 and translate the universal command into a vendor-specific command that is formatted in the language specific to projectors sourced from Vendor 3. The projector 806 can then be controlled in accordance with the vendor-specific command to service the pick order (e.g., perform one or more steps in the process of servicing the pick order). For instances in which the projector 806 is replaced with a new projector sourced from a different vendor, the WES software engine 314 is modified to include and/or implement a second projector CM 318 that is adapted to control a projector sourced from the different vendor.

Further in this example, the WES software engine 314 implements a conveyor manager 316 to generate and publish universal commands for controlling the conveyor 808 to service the pick order. In addition, the WES software engine 314 includes and/or implements a first conveyor CM 318 that is adapted to control the conveyor 808 sourced from Vendor 4. The first conveyor CM 318 can detect a universal command generated by the conveyor manager 316 and translate the universal command into a vendor-specific command that is formatted in the language specific to conveyors sourced from Vendor 4. The conveyor 808 can then be controlled in accordance with the vendor-specific command to service the pick order (e.g., perform one or more steps in the process of servicing the pick order). For instances in which the conveyor 808 is replaced with a new conveyor sourced from a different vendor, the WES software engine 314 is modified to include and/or implement a second conveyor CM 318 that is adapted to control a conveyor sourced from the different vendor.

Further in this example, the WES software engine 314 implements a UI manager 316 to generate and publish universal commands for controlling the UI 810 to service the pick order. In addition, the WES software engine 314 includes and/or implements a first UI CM 318 that is adapted to control the UI 810 sourced from Vendor 5. The first UI CM 318 can detect a universal command generated by the UI manager 316 and translate the universal command into a vendor-specific command that is formatted in the language specific to UIs sourced from Vendor 5. The UI 810 can then be controlled in accordance with the vendor-specific command to service the pick order (e.g., perform one or more steps in the process of servicing the pick order). For instances in which the UI 810 is replaced with a new UI sourced from a different vendor, the WES software engine 314 is modified to include and/or implement a second UI CM 318 that is adapted to control a UI sourced from the different vendor.

In some examples, the WES software engine 314 can further include and/or implement an overall GTP manager 316 that orchestrates operation of the other managers 316 associated with the GTP system 800. For example, the GTP manager 316 can orchestrate operation of one or more of the ASRS manager 816, the pick light manager 316, the projector manager 316, the conveyor manager 316, and/or the UI manager 316 when the GTP system 800 is used to service a request.

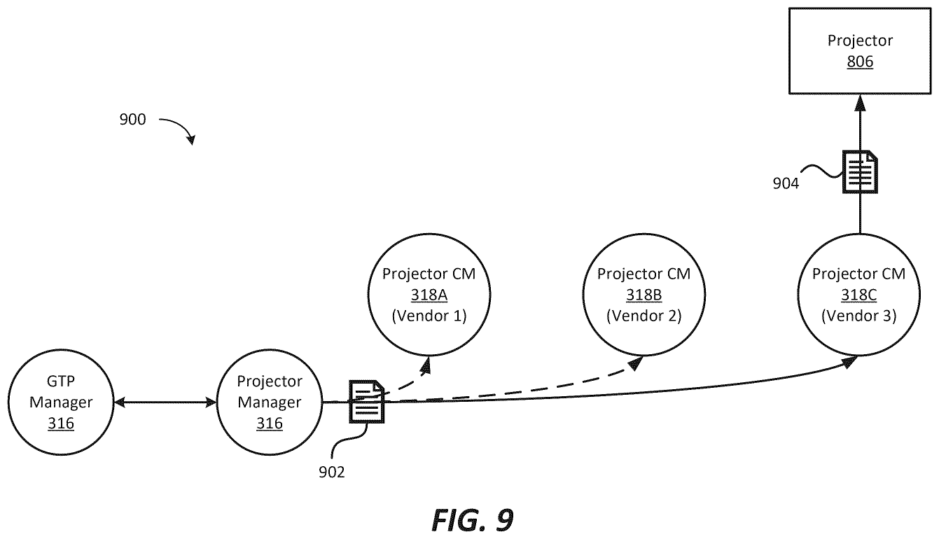

FIG. 9 illustrates an example workflow 900 for controlling a projector 806 using a GTP manager 316, according to the present teachings. As shown in FIG. 9, the GTP manager 316 controls and interfaces with the projector manager 316 to generate universal, device-agnostic commands 902 for controlling projectors. Depending on which vendor the projector 806 installed in the GTP system 800 is sourced from, a respective projector CM 318 will detect and translate the universal, device-agnostic command 902 into a vendor-specific command 904 for controlling the projector 806. In this example, since the projector 806 is sourced from Vendor 3, the projector CM 318C associated with Vendor 3 will detect and translate the universal command 902 into a vendor-specific command 904 formatted in accordance with projectors sourced from Vendor 3. The projector 806 can then operate in accordance with the vendor-specific command 904.

In the illustrated example of FIG. 9, the projector CM 318A associated with Vendor 1 and the projector CM 318B associated with Vendor 2 are shown to ignore the universal command 902 generated by the projector manager 316. However, in some examples, the projector CMs 318A and 318B still generate respective vendor-specific commands based on the universal command 902 generated by the projector manager 316. In such examples, these vendor-specific commands are not used to control any projector.

In some examples, the WES software engine 314 can use a combination of device managers 316 to control a conveyor included in a materials handling system 200, such as the conveyor 808 included in the GTP system 800. For example, the WES software engine 314 can implement a conveyor routing manager 316 and a PLC manager 316 to generate universal commands for controlling a conveyor 800 included in the materials handling system 200 and/or the GTP system 800.

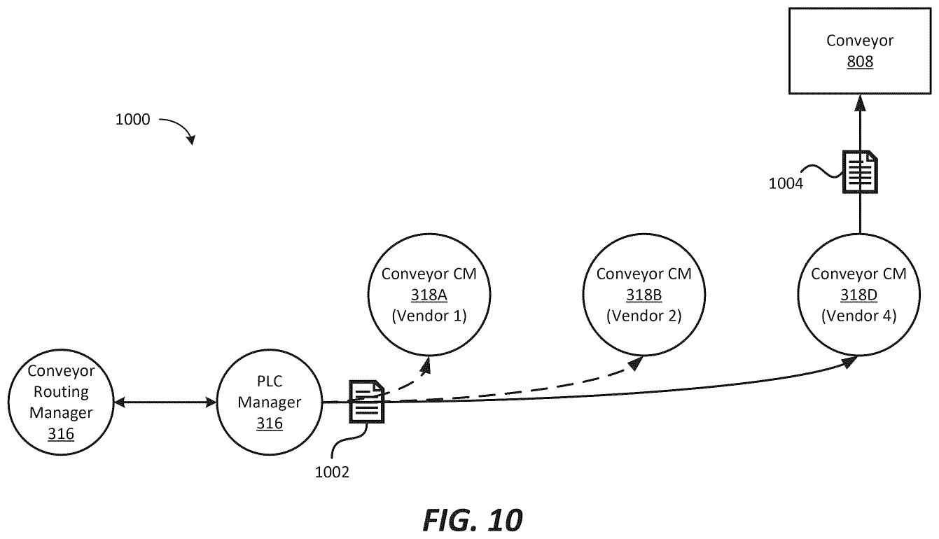

FIG. 10 illustrates an example workflow 1000 for controlling a conveyor 808 using a conveyor routing manager 316 and a PLC manager 316, according to the present teachings. As shown in FIG. 10, the conveyor routing manager 316 controls and interfaces with the PLC manager 316 to generate universal, device-agnostic commands 1002 for controlling conveyor. Depending on which vendor the conveyor 808 is sourced from, a respective conveyor CM 318 will detect and translate the universal, device-agnostic command 1002 into a vendor-specific command 1004 for controlling the conveyor 808. In this example, since the conveyor 808 is sourced from Vendor 4, the conveyor CM 318D associated with Vendor 4 will detect and translate the universal command 1002 into a vendor-specific command 1004 formatted in accordance with conveyor sourced from Vendor 4. The conveyor 808 can then operate in accordance with the vendor-specific command 1004.

Although certain aspects have been described with reference to certain examples, variations and modifications exist within the spirit and scope of one or more independent aspects. Various features and aspects are set forth in the following claims.

Any and all combinations of any of the claim elements recited in any of the claims and/or any elements described in this application, in any fashion, fall within the contemplated scope of the present disclosure and protection. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method of operating a materials handling system, comprising:
receiving a request associated with the materials handling system;
identifying an automation device included in the materials handling system that can be used to service the request, the automation device associated with a vendor;
generating, by a device manager implemented in a warehouse execution system (WES), a universal command for controlling the automation device to service the request;
generating, by a communication microservice implemented in the WES based in part on the universal command, a vendor-specific command that is in a format associated with the vendor; and
controlling the automation device in accordance with the vendor-specific command.

2. The method of claim 1, wherein the automation device includes at least one of a conveyor, a shuttle, a lift, or a crane.

3. The method of claim 1, wherein the automation device is a goods-to-person system including a conveyor, a projector, a pick light, an automated storage and retrieval system (ASRS), and a user-interface.

4. The method of claim 1, further comprising:
receiving, from a sensor, data indicative of an operating state of the automation device; and
detecting, based in part on the data, a fault associated with the automation device.

5. The method of claim 4, further comprising:
generating an alert indicative of the fault; and
transmitting the alert to a computing device associated with maintenance personnel.

6. The method of claim 4, further comprising replacing the automation device with a second automation device, the second automation device associated with a second vendor.

7. The method of claim 6, further comprising:
receiving a second request associated with the materials handling system;
generating, by the device manager, a second universal command for controlling the second automation device to service the second request;
generating, by a second communication microservice implemented in the WES based in part on the second universal command, a second vendor-specific command that is in a format associated with the second vendor; and
controlling the second automation device in accordance with the second vendor-specific command.

8. The method of claim 7, further comprising configuring the WES with the second communication microservice.

9. The method of claim 6, wherein the automation device and the second automation device are of a same type.

10. A materials handling system, comprising:
a plurality of automation devices; and
a computing system that is in electronic communication with the plurality of automation devices, the computing system adapted to execute a warehouse execution system (WES) engine to:
receive a request associated with the materials handling system;
identify a first automation device included in the plurality of automation devices that can be used to service the request, the first automation device associated with a first vendor;
generate, by a device manager, a universal command for controlling the first automation device to service the request;
generate, by a communication microservice based in part on the universal command, a vendor-specific command that is in a format associated with the first vendor; and
control the first automation device in accordance with the vendor-specific command.

11. The system of claim 10, wherein the computing system is further adapted to execute the WES engine to:
publish, by the device manager, the universal command on a data streaming platform; and
detect, by the communication microservice, the universal command published on the data streaming platform.

12. The system of claim 11, wherein to generate the vendor-specific command, the communication microservice translates the universal command into a language associated with the first vendor.

13. The system of claim 10, wherein the computing system is further adapted to execute the WES engine to:
receive, from a sensor, data indicative of an operating state of the first automation device; and
determine, based in part on the data, that a fault associated with the first automation device has occurred.

14. The system of claim 13, wherein the computing system is further adapted to execute the WES engine to:
generate an alert indicative of the fault; and
transmit the alert to a computing device associated with maintenance personnel.

15. The system of claim 10, wherein the computing system is further adapted to execute the WES engine to:
receive a second request associated with the materials handling system;
identify a second automation device included in the plurality of automation devices that can be used to service the second request, the second automation device associated with a second vendor;
generate, by the device manager, a second universal command for controlling the second automation device to service the second request;
generate, by a second communication microservice, a second vendor-specific command that is in a format associated with the second vendor; and
control the second automation device in accordance with the second vendor-specific command.

16. The system of claim 15, wherein the computing system is further adapted to execute the WES engine to:
publish, by the device manager, the second universal command on a data streaming platform;
detect, by the communication microservice, the second universal command published on the data streaming platform;
detect, by the second communication microservice, the second universal command published on the data streaming platform; and
translate, by the second communication microservice, the second universal command into a language associated with the second vendor.

17. The system of claim 15, wherein the automation device is a first crane sourced from the first vendor and the second automation device is a second crane sourced from the second vendor.

18. The system of claim 10, wherein the device manager includes a conveyor routing manager and a programmable logic controller (PLC) manager.

19. The system of claim 10, wherein the plurality of automation devices includes a conveyor associated with the first vendor, a user-interface associated with a second vendor, a shuttle associated with a third vendor, a projector associated with a fourth vendor, and a pick light associated with a fifth vendor.

20. The system of claim 19, wherein the automation device is the conveyor associated with the first vendor; and
wherein the computing system is further adapted to execute the WES engine to instruct, by a goods-to-person manager, the device manager to generate the universal command.
